(19) United States
(12) Patent Application Publication
(10) Pub. No.: US 2015/0080596 A1
(43) Pub. Date: Mar. 19, 2015

(54) Method Of Reducing A Halosilane Compound In A Micoreactor

(71) Applicant: Dow Corning Corporation, Midland, MI (US)

(72) Inventors: Binh Thanh Nguyen, Midland, MI (US); Simon Parsley, Midland, MI (US); Jacob Remacle, Midland, MI (US); Levon Shahinian, Midland, MI (US); Hanh Vo, Midland, MI (US)

(21) Appl. No.: 14/379,011

(22) PCT Filed: Feb. 14, 2013
(86) PCT No.: PCT/US2013/026169

§ 371 Date: Aug. 15, 2014

Related U.S. Application Data
(60) Provisional application No. 61/599,505, filed on Feb. 16, 2012.

(51) Int. Cl. C07F 7/08

(52) U.S. Cl. CPC C07F 7/0896
USPC 556/474; 556/487

(57) ABSTRACT

A method of producing a hydrosilane compound in a microreactor comprises reducing a halosilane compound in the microreactor and in the presence of a reducing agent to produce the hydrosilane compound.

### BACKGROUND OF THE INVENTION

The subject invention generally relates to a method of producing a hydrosilane compound and, more specifically, to a method of producing a hydrosilane compound in a microreactor.

Silicon hydrides are generally known in the art and include at least one silicon-bonded hydrogen atom. Silicon hydrides, such as silicon tetrahydride, or monosilane, are utilized in various applications, including deposition of elemental silicon on a substrate. Methods of preparing silicon hydrides are also generally known in the art. For example, silicon hydrides can be prepared from conventional reactions involving halosilane compounds. However, these conventional reactions are exothermic and require continuous heat monitoring and removal. Moreover, catalysts utilized in the conventional reactions, as well as the silicon hydrides themselves, are pyrophoric, i.e., these compounds may ignite spontaneously in air or moisture. Accordingly, these conventional reactions pose great risk to equipment and human life.

### SUMMARY OF THE INVENTION

The subject invention provides a method of producing a hydrosilane compound in a microreactor. The method comprises reducing a halosilane compound in the microreactor and in the presence of a reducing agent to produce the hydrosilane compound. The hydrosilane compound includes at least one more silicon-bonded hydrogen atom than the halosilane compound includes, if any. Further, the halosilane compound includes at least one more silicon-bonded halogen atom than the hydrosilane compound includes, if any. The subject invention also provides a hydrosilane compound formed from the method.

### DETAILED DESCRIPTION OF THE INVENTION

The present invention provides a method of producing a hydrosilane compound in a microreactor from a halosilane. The hydrosilane compound produced by the method of the present invention can be utilized in various applications, such as a starting material for deposition of elemental silicon. However, the hydrosilane compound is not limited to such an application. For example, the hydrosilane compound produced by the method of the present invention may be utilized as a coupling agent for a polymer matrix.

As introduced above, the hydrosilane compound is produced from a halosilane compound. The halosilane compound may be any halosilane compound having at least one silicon-bonded halogen atom. For example, the halosilane compound may comprise a halogenated monosilane compound, i.e., the halosilane compound may include one silicon atom. Alternatively, the halosilane compound may comprise a halogenated polysilane compound, i.e., the halosilane compound may comprise more than one silicon atom, in which the silicon atoms are typically bonded to one another. Said differently, the silicon atoms of the halogenated polysilane compound are generally not separated via oxygen atoms, as in traditional siloxanes having a Si—O—Si backbone. The halosilane compound may comprise mixtures of different types of halogenated monosilane compounds, mixtures of different types of halogenated polysilane compounds, or mixtures of halogenated monosilane compounds and halogenated polysilane compounds. When the halosilane compound includes more than one silicon-bonded halogen atom, each halogen atom may independently be selected from F, Cl, Br, or I; alternatively, each halogen atom may independently be selected from Cl, Br, or I; alternatively, each halogen atom may independently be selected from Cl or Br. Most typically, all of the halogen atoms of the halosilane compound are Cl.

The halogenated monosilane compound typically has the following general formula (1):

RₐH_{b}X_{4-a-b}Si,

wherein each R is independently selected from a substituted hydrocarbyl group, a unsubstituted hydrocarbyl group and an amino group, each X is independently a halogen atom, and a and b are each independently an integer from 0 to 3 with the proviso that a+b equals an integer from 0 to 3.
Because a+b equals an integer from 0 to 3, the halogenated monosilane compound implicitly includes at least one silicon-bonded halogen atom, which is represented by X in the general formula above.

In certain embodiments, subscript a in general formula (1) above is at least 1 such that the halogenated monosilane compound includes at least one substituent represented by R. Generally, the substituent represented by R is non-reactive with respect to the reaction of the halosilane compound to produce the hydrosilane compound. However, the substituent represented by R in general formula (1) may be reactive with other functionalities, reagents, catalysts, or other compounds or components that are not generally present during the method of producing the hydrosilane compound. Examples of unsubstituted hydrocarbyl groups include alkyl groups, aryl groups, alkenyl groups, cycloalkyl groups, cycloalkene groups, and combinations thereof. Examples of combinations of such groups include aryl-substituted alkyl groups and alkyl-substituted aryl groups. Examples of alkyl groups include C₁-C₁₀ alkyl groups. One example of an aryl group is a phenyl group. Examples of alkenyl groups include C₁-C₁₀ alkenyl groups where the ethylenically unsaturated moiety of the alkenyl groups may be present at any location within the alkenyl groups, i.e., the ethylenically unsaturated moiety of the alkenyl groups may be terminal or may be located within the aliphatic chain such that the alkenyl groups terminate with a CH₃ group. Examples of cycloalkyl groups include 2-methylcyclopropyl groups, cyclopropyl groups, cyclobutyl groups, cyclopentyl groups, cyclohexyl groups, and cycloheptyl groups. Examples of cycloalkenyl groups include cyclopentenyl groups, cyclohexenyl groups, and cycloheptenyl groups. The substituted hydrocarbyl group includes at least one substituent. The substituent may be independently selected from, for example, halogen atoms and amino groups. Examples of substituted hydrocarbyl groups include halogenated hydrocarbyl groups, such as haloalkyl groups. Examples of amino groups include NR¹₂, NHR¹, and NH₂, where R¹ is an independently selected hydrocarbyl group, such as the hydrocarbyl groups set forth above, provided that two R¹ may together form a hydrocarbylene group (such as an alkylene group, e.g. a 1,4-butylene group), although each R¹ is typically independently selected from C₁-C₁₀ alkyl groups.

In certain embodiments in which the halosilane compound comprises the halogenated monosilane compound represented by general formula (1) above, subscript b of general formula (1) is an integer from 0 to 2, typically from 0 to 1, most typically 0, such that the halosilane compound does not include any silicon bonded hydrogen atoms. In these embodiments, i.e., embodiments in which subscript a of general formula (1) is at least 1 and subscript b of general formula (1) is 0, examples of the halosilane compound include C₆H₅SiCl₃, (C₆H₅)₂SiCl₂, (C₆H₅)₃SiCl, CH₃SiCl₃, (CH₃)₂SiCl₂, (CH₃)₃SiCl, (CH₃)(CH₃CH₂CH₂)(C₆H₅)SiCl, CH₃SiHCl₂, (C₆H₅)₂CH₃SiCl, C₆H₅(CH₃)₂SiCl, (C₆H₅)(CH₃)SiCl₂, (CH₃CH₂)(CH₃)₂SiCl, (CH₃CH₂)₂(CH₃)SiCl, (C₆H₅)₂(CH₃CH₂)SiCl, (CH₃CH₂CH₂)SiCl₃, (CH₃CH₂CH₂CH₂) (C₆H₅)SiCl₂, and the like.

In other embodiments in which the halosilane compound comprises the halogenated monosilane compound, subscript a of general formula (1) is 0 such that the halosilane compound does not include any substituents represented by R. In these embodiments, the halosilane compound may include four silicon-bonded halogen atoms, i.e., the halosilane compound may be the general formula SiX₄, where X is defined above. Alternatively, the halosilane compound may include a combination of silicon-bonded halogen atoms and silicon-bonded hydrogen atoms. For example, in embodiments in which the halosilane compound does not include any substituents represented by R, the halosilane compound may be represented by general formula (2)

H_{b′}X_{4-b′}Si,

wherein X is defined above and b′ is an integer from 0 to 3. Because b′ is an integer from 0 to 3, the halosilane compound implicitly includes at least one silicon-bonded halogen atom, which is represented by X in general formula (2) above. Examples of the halosilane compound represented by general formula (2) above include SiX₄, HSiX₃, H₂SiX₂, and H₃SiX, alternatively SiCl₄, HSiCl₃, H₂SiCl₂, and H₃SiCl.

As set forth above, the halosilane compound may comprise a halogenated polysilane compound, i.e., the halosilane compound may comprise more than one silicon atom. In these embodiments, the halosilane compound typically has the following general formula (3):

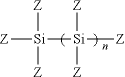

wherein each Z is independently selected from a substituted hydrocarbyl group, an unsubstituted hydrocarbyl group, an amino group, a hydrogen atom, and a halogen atom, with the proviso that at least one Z is a halogen atom, and n is an integer from 1 to 20, alternatively from 1 to 5, alternatively from 1 to 3, alternatively 3, alternatively 2, alternatively 1.

In certain embodiments in which the halosilane compound comprises the halogenated polysilane compound represented by general formula (3) above, at least one Z is a substituted or unsubstituted hydrocarbyl group or an amino group. Generally, the substituted or unsubstituted hydrocarbyl group or the amino group is non-reactive with respect to the reaction of the halosilane compound to produce the hydrosilane compound. However, the substituted or unsubstituted hydrocarbyl group and Z or the amino group may be reactive with other functionalities, reagents, catalysts, or other compounds or components that are not generally present during the method of producing the hydrosilane compound. Exemplary examples of substituted or unsubstituted hydrocarbyl groups and amino groups are set forth above with respect to the halogenated monosilane compound.

In various embodiments when the halosilane compound comprises the halogenated polysilane compound represented by general formula (3) above and when the halosilane includes at least one substituted or unsubstituted hydrocarbyl group or an amino group, the halosilane compound does not include any silicon bonded hydrogen atoms. In these embodiments, examples of the halosilane compound include the following compounds:

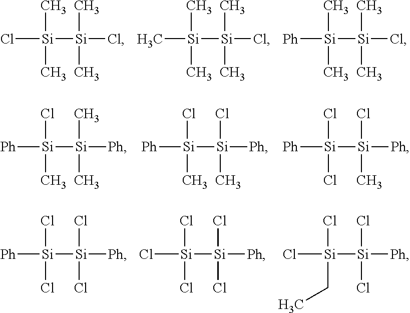

and the like.

In other embodiments in which the halosilane compound comprises the halogenated polysilane compound, the halosilane compound does not include any substituted or unsubstituted hydrocarbyl groups or amino groups. In these embodiments, the halosilane compound may include only silicon-bonded halogen atoms. Alternatively, the halosilane compound may include a combination of silicon-bonded halogen atoms and silicon-bonded hydrogen atoms. Examples of the halosilane compound when the halosilane compound does not include any substituted or unsubstituted hydrocarbyl groups or amino groups include, but are no limited to, the following compounds:

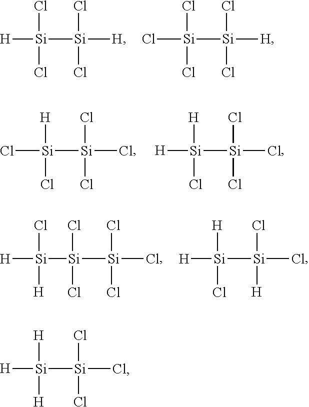

and the like.

The method of producing the hydrosilane compound comprises reducing the halosilane compound in the microreactor and in the presence of a reducing agent to produce the hydrosilane compound.

Reducing the halosilane compound in the microreactor and in the presence of the reducing agent produces the hydrosilane compound, which includes at least one more silicon-bonded hydrogen atom than the halosilane compound, if any. Consequently, the halosilane compound includes at least one more silicon-bonded halogen atom than the hydrosilane compound, if any. Said differently, reducing the halosilane compound typically comprises formally replacing at least one silicon-bonded halogen atom of the halosilane compound with at least one hydrogen atom to produce the hydrosilane compound. More than one silicon-bonded halogen atom of the halosilane compound may be reduced, i.e., formally replaced, with hydrogen atoms, dependent upon the number of silicon-bonded halogen atoms of the halosilane compound. In certain embodiments, reducing the halosilane compound comprises replacing every silicon-bonded halogen atom of the halosilane compound with a hydrogen atom to produce the hydrosilane compound. As but one example, when the halosilane compound comprises four silicon-bonded halogen atoms, the hydrosilane compound produced by reducing the halosilane compound may include four silicon-bonded hydrogen atoms, three silicon-bonded hydrogen atoms and one silicon-bonded halogen atom, two silicon-bonded hydrogen atoms and two silicon-bonded halogen atoms, or one silicon-bonded hydrogen atom and three silicon-bonded halogen atoms.

As a further example, in certain embodiments in which the halosilane compound comprises the halogenated monosilane compound represented by general formula (1) above, the hydrosilane compound may be represented by the following general formula (4):

RₐH_{b+1}X_{4-a-b-1}Si

wherein R, X and subscripts a and b are defined above. The hydrosilane compound represented by general formula (4) above is representative of embodiments in which reducing the halosilane compound comprises replacing one silicon-bonded halogen atom of the halosilane compound with one silicon-bonded hydrogen atom to produce the hydrosilane compound. However, as introduced above, reducing the halosilane compound may replace more than one silicon-bonded halogen atom of the halosilane compound with silicon-bonded hydrogen atoms. This is contingent on both the number of substituents represented by R in the halosilane compound and the number of silicon-bonded halogen atoms in the halosilane compound. For example, in certain embodiments in which the halosilane compound comprises the halogenated monosilane compound represented by general formula (1) above, and when all of the silicon-bonded halogen atoms of the halosilane compound are replaced by silicon-bonded hydrogen atoms to form the hydrosilane compound, the hydrosilane compound may be represented by general formula (5) below

RₐH_{b″}Si,

wherein R and subscript are defined above, and b″ is an integer from 1 to 4, with the proviso that a+b″=4.

Alternatively, in certain embodiments in which the halosilane compound comprises the halogenated polysilane compound represented by general formula (3) above, the hydrosilane compound may be represented by the following general formula (6) below:

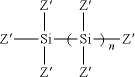

wherein each Z′ is independently selected from a substituted or unsubstituted hydrocarbyl group, an amino group, a hydrogen atom, and a halogen atom, with the proviso that at least one Z′ is a hydrogen atom, and n is an integer from 1 to 20, as defined above. The number of Z's in general formula (6) above that represent silicon-bonded hydrogen atoms is contingent on many factors, such as the number of substituents other than silicon-bonded hydrogen atoms present in the halosilane compound, the number of silicon-bonded halogen atoms present in the halosilane compound and the number of silicon-bonded halogen atoms which are replaced by silicon-bonded hydrogen atoms in the hydrosilane compound during the step of reducing the halosilane compound. For example, when all of the substituents represented by Z in general formula (3) are halogen atoms, all of the substituents or less than all of the substituents represented by Z′ in general formula (6) may be hydrogen atoms.

The halosilane compound is reduced in the microreactor in the presence of the reducing agent. Typically, the reducing agent comprises a metal hydride, although the reducing agent can be any compound suitable for reducing the halosilane compound. The metal hydride can be any metal hydride capable of converting at least one of the silicon-bonded halogen atoms of the halosilane compound to silicon-bonded hydrogen atoms. Metal hydrides suitable for the purposes of the present invention include hydrides of sodium, magnesium, potassium, lithium, boron, calcium, titanium, zirconium, and aluminum. The metal hydride can be a simple (binary) metal hydride or a complex metal hydride. Most typically, the reducing agent is in the form of a liquid comprising the reducing agent, e.g. the metal hydride, such that the reducing agent can be fed into the microreactor without clogging or otherwise blocking microchannels defined by the microreactor. Additionally, during the step of reducing the halosilane compound, the reducing agent is often converted to a halide salt. Accordingly, the reducing agent is typically selected such that the halide salt of the reducing agent is also a liquid to prevent clogging of the microchannels defined by the microreactor.

Examples of metal hydrides include diisobutylaluminum hydride (DIBAH), sodium dihydro-bis-(2-methoxyethoxy)aluminate (Vitride), aluminum hydride, lithium hydride, sodium hydride, sodium borohydride, lithium aluminum hydride, sodium aluminum hydride, lithium borohydride, magnesium hydride, calcium hydride, titanium hydride, zirconium hydride, etc. It certain embodiments, the reducing agent is disposed in a carrier vehicle, such as a solvent or dispersant. The solvent may be an aliphatic or aromatic hydrocarbon solvent, an ether solvent, etc. One example of an aromatic hydrocarbon solvent is toluene. Examples of aliphatic hydrocarbon solvents include isopentane, hexane, heptane, etc. One example of an ether solvent is tetrahydrofuran (THF). When disposed in the solvent, the reducing agent typically has a molarity (M) of from 0.5 to 2.0, alternatively from 0.75 to 1.75, alternatively from 0.9 to 1.6. Alternatively, because at least some reducing agents may be liquids, the reducing agent may be utilized in a concentrated form without being disposed in the carrier vehicle, i.e., in the absence of a carrier vehicle other than the hydrosilane compound, the halosilane compound, and the reducing agent. Methods of preparing metal hydrides are well known in the art and many of these compounds are commercially available from various suppliers.

The amount of the reducing agent utilized may vary dependent upon the particular reducing agent selected, the particular halosilane compound utilized, the reduction parameters employed, and the desired hydrosilane compound to be produced. The molar ratio of the reducing agent and the halosilane compound utilized when producing the hydrosilane compound influences conversion and selectivity. In fact, the molar ratio of the reducing agent and the halosilane compound influences selectivity more than other parameters, such as temperature, concentration, feed rate, and a configuration of the microreactor.

In particular, the molar ratio of the reducing agent to the halosilane compound is generally from 0.01:1.0 to 5.0:1.0, alternatively from 0.1:1.0 to 4.0:1.0, alternatively from 0.2:1.0 to 2.5:1.0.

Selectivity relates to the molar ratio of each species in the hydrosilane compound produced by reducing the halosilane compound. For example, when the halosilane compound includes more than one silicon-bonded halogen atom, the hydrosilane compound may comprise a fully reduced species and one or more partially reduced species. As but one example, when the halosilane compound comprises phenyltrichlorosilane (C₆H₅SiCl₃), the hydrosilane compound formed from reducing the halosilane compound may comprise phenylsilane (C₆H₅SiH₃), phenylchlorosilane ((C₆H₅)H₂SiCl), and Z or phenyldichlorosilane ((C₆H₅)HSiCl₂). In these embodiments, phenylsilane (C₆H₅SiH₃) is the fully reduced species, and phenylchlorosilane ((C₆H₅)H₂SiCl) and phenyldichlorosilane ((C₆H₅)HSiCl₂) are the partially reduced species. Depending upon the application in which the hydrosilane compound is utilized, the partially reduced species or the fully reduced species may be more desirable. Selectivity may refer to the molar ratio of any one of these species in the hydrosilane compound. Conversion, on the other hand, generally refers to the molar fraction based on silicon of the halosilane compound which is reduced to produce the hydrosilane compound.

At lower molar ratios of the reducing agent to the halosilane compound, such as 0.2:1.0, conversion is typically 30% or less, alternatively 25% or less, alternatively 20% or less. At higher molar ratios of the reducing agent to the halosilane compound, such as greater than or equal to 2.0:1.0, conversion of more than 60%, alternatively greater than 70%, alternatively greater than 80%, alternatively greater than 90%, of the halosilane compound can be obtained. Accordingly, dependent upon the molar ratio of the reducing agent to the halosilane compound, the conversion of the halosilane compound to produce the hydrosilane compound may be selectively controlled.

At lower molar ratios of the reducing agent to the halosilane compound, the selectivity of the partially reduced species is generally greater than the selectivity of the fully reduced species in the hydrosilane compound. For example, at lower molar ratios of the reducing agent to the halosilane compound, such as 0.2:1.0, and when the halosilane compound comprises phenyltrichlorosilane (C₆H₅SiCl₃), the selectivity of the fully reduced species, i.e., phenylsilane (C₆H₅SiH₃), is typically about 10 to about 20%. In these embodiments, selectivity of the partially reduced species, i.e., phenylchlorosilane ((C₆H₅)H₂SiCl), and phenyldichlorosilane ((C₆H₅)HSiCl₂), makes up the bulk of the hydrosilane compound, with the selectivity of the phenyldichlorosilane ((C₆H₅)HSiCl₂) generally being the highest value. In contrast, at high molar ratios of the reducing agent to the halosilane compound, such as greater than or equal to 2.0:1.0, the selectivity of the fully reduced species, i.e., phenylsilane (C₆H₅SiH₃), is typically about 90 to about 100%. In these embodiments, minimal amounts, if any, of the partially reduced species, i.e., phenylchlorosilane ((C₆H₅)H₂SiCl), and phenyldichlorosilane ((C₆H₅)HSiCl₂), are present in the hydrosilane compound.

As but one non-limiting example of the various species, including the partially reduced species and the fully reduced species, that may be formed from reducing the halosilane compound in the presence of the reducing agent, the follow reaction illustrates a reaction in which the reducing agent comprises diisobutylaluminum hydride (DIBAH) and the halosilane compound comprises phenyltrichlorosilane (C₆H₅SiCl₃):

6DIBAH+3C₆H₅SiCl₃→C₆H₅SiH₃+(C₆H₅)H₂SiCl+(C₆H₅)HSiCl₂+6DIBACl

As illustrated in the reaction above, the hydrosilane compound formed from reducing the halo silane compound in the presence of the reducing agent comprises phenylsilane (C₆H₅SiH₃), phenylchlorosilane ((C₆H₅)H₂SiCl), and phenyldichlorosilane ((C₆H₅)HSiCl₂). The phenylsilane is fully reduced, whereas the phenylchlorosilane and the phenyldichlorosilane are partially reduced. Additionally, the reducing agent, i.e., diisobutylaluminum hydride (DIBAH), is converted to a halide salt, i.e., diisobutylaluminum chloride (DIBACl). The reaction above assumes 100% conversion of the phenyltrichlorosilane (C₆H₅SiCl₃), although residual and Z or unreacted phenyltrichlorosilane (C₆H₅SiCl₃) may remain after reducing the phenyltrichlorosilane (C₆H₅SiCl₃).

As another non-limiting example of the various species, including the partially reduced species and the fully reduced species, which may be formed from reducing the halosilane compound in the presence of the reducing agent, the following reaction illustrates a reaction in which the reducing agent comprises diisobutylaluminum hydride (DIBAH) and the halosilane compound comprises tetrachlorosilane (SiCl₄):

10DIBAH+4SiCl₄→SiH₄+H₃SiCl+H₂SiCl₂+HSiCl₃+10DIBACl

As illustrated in the reaction above, the hydrosilane compound formed from reducing the halosilane compound in the presence of the reducing agent comprises monosilane (SiH₄), chlorosilane (H₃SiCl), dichlorosilane (H₂SiCl₂) and trichlorosilane (HSiCl₃). The monosilane is fully reduced, whereas the chlorosilanes, dichlorosilane and trichlorosilane are partially reduced. Additionally, the reducing agent, i.e., diisobutylaluminum hydride (DIBAH), is converted to the halide salt, i.e., diisobutylaluminum chloride (DIBACl). The reaction above assumes 100% conversion of the tetrachlorosilane (SiCl₄), although residual and Z or unreacted tetrachlorosilane (SiCl₄) may remain after reducing the tetrachlorosilane (SiCl₄).

The halosilane compound may be reduced in the microreactor in the presence of the reducing agent and the carrier vehicle, e.g. the solvent or the dispersant, to produce the hydrosilane compound. The carrier vehicle is distinct from the halosilane compound, the reducing agent, and the hydrosilane compound. Alternatively, the halosilane compound may be reduced in the microreactor in the presence of the reducing agent and in the absence of the carrier vehicle to produce the hydrosilane compound. This process is generally referred to as a neat process.

In embodiments in which the halosilane compound is reduced in the presence of the reducing agent and the carrier vehicle, e.g. the solvent or the dispersant, the carrier vehicle may be present and Z or provided along with the reducing agent. Alternatively, the carrier vehicle may be a discrete component that is utilized in combination with the halosilane compound and Z or the reducing agent. In other embodiments, the carrier vehicle may be disposed in the microreactor independently and separately from the reducing agent and the halo silane compound. Examples of solvents suitable for the purposes of the method include hydrocarbon solvents, e.g. linear, branched, and Z or aromatic hydrocarbon solvents; ether solvents, e.g. tetrahydrofuran, diethyl ether, ethylene ether, propylene ether, and dimethylethyleneglycol; and combinations thereof.

The microreactor utilized in the method has a much greater surface area to volume ratio than conventional reactors, and thus offers a much greater heat transfer per volume than conventional reactors. Accordingly, heat can be continuously and rapidly withdrawn from the reaction to produce the hydrosilane compound when the hydrosilane compound is produced in the microreactor, thereby reducing or even obviating risks associated with such exothermic reactions.

In certain embodiments, the microreactor defines at least one reaction chamber or volumetric space for containing or carrying out the reaction to produce the hydrosilane compound. The microreactor may define a plurality of reaction chambers and Z or volumetric spaces, or the microreactor may define a single reaction chamber or volumetric space. The reaction chamber or volumetric space of the microreactor typically has a surface area to volume ratio of at least 1,500:1, alternatively at least 2,000:1, alternatively at least 2,250:1, alternatively at least 2,400:1, alternatively from 2,450:1 to 2,550:1. The microreactor typically has an overall volume of from 25 to 89, alternatively from 35 to 79, alternatively from 45 to 79, alternatively from 50 to 74, milliliters (mL). However, the microreactor may have an overall volume greater or less than the overall volume set forth above contingent upon dimensions and size of the microreactor. Typically, a largest internal dimension of each volumetric space or reaction chamber of the microreactor is less than 1 mm. The overall volume referenced above relates to an internal volume defined by the microreactor in which the reaction to produce the hydrosilane compound is carried out or otherwise contained. Accordingly, this overall volume includes the halosilane compound, the reducing agent, the hydrosilane compound, and any other optional components or byproducts. The microreactor is generally formed from an inert material, such as glass, or a glass-based material, e.g. borosilicate glass. One example of a suitable microreactor is the Corning® Advanced-Flow™ reactor, commercially available from Corning Incorporated of Corning, N.Y. Another example of a suitable microreactor is described in U.S. Pat. No. 7,007,709, which is incorporated by reference herein in its entirety.

In certain embodiments and configurations, specialized fittings and Z or tubing is required for connecting various elements utilized in the method, such as the microreactor and a positive displacement syringe pump for feeding the halosilane compound, the reducing agent, and the solvent (when present) into the microreactor. Generally, such specialized fittings and Z or tubing are formed from stainless steel, although other inert metals or materials may be utilized. The halosilane compound, the reducing agent, and the solvent (when present) are typically fed into the microreactor by at least one positive displacement syringe pump at a flow rate of from 14.3 to 34.3, alternatively 19.3 to 29.3, alternatively 21.3 to 27.3, milliliters per minute (mL Z min). This flow rate may vary dependent upon the molar ratio of reducing agent to halosilane compound desired, as well as the presence or absence of solvent.

The method of producing the hydrosilane compound in the microreactor may be a batch process, a semi-batch process, or a continuous process, although the method is typically a continuous process. However, it is to be appreciated that the continuous process requires an initial period of time to reach a steady state. In certain embodiments, a fluid recirculator is utilized for controlling temperature during the step of reducing the halosilane compound. The fluid recirculator may use various fluids for chilling the microreactor and its contents, such as Dow Corning 200® fluid. The fluid recirculator may be integral with the microreactor or may be separate from and coupled to the microreactor. For example, in one embodiment, the microreactor includes a first fluidic layer for reducing the halosilane compound, and a second fluidic layer for circulating the fluid to control temperature during the step of reducing the halosilane compound.

In certain embodiments, the hydrosilane compound produced from reducing the halosilane compound is a gas at ambient conditions and at the conditions of the microreactor. In such instances, the hydrosilane compound may be purified and collected via distillation or other similar purification methods.

The hydrosilane compound produced from reducing the halosilane compound may be captured and stored for future use, or may be utilized in a process coupled to the microreactor.

One or more of the values described above may vary by 5%, 10%, 15%, 20%, 25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein. The following examples are intended to illustrate the invention and are not to be viewed in any way as limiting to the scope of the invention.

The following examples are intended to illustrate embodiments of the invention and are not to be viewed in any way as limiting to the scope of the invention.

### Examples

### Examples 1-11

A halosilane compound is reduced in a microreactor in the presence of a reducing agent to produce a hydrosilane compound. The halosilane compound comprises phenyltrichlorosilane (C₆H₅SiCl₃). The reducing agent comprises diisobutylaluminum hydride (DIBAH) (either in toluene or without a solvent). The hydrosilane compound comprises phenylsilane (C₆H₅SiH₃), phenylchlorosilane ((C₆H₅)H₂SiCl), and phenyldichlorosilane ((C₆H₅)HSiCl₂). The step of reducing the halosilane compound in the presence of the reducing agent to form the hydrosilane compound can be illustrated by the following reaction:

6DIBAH+3C₆H₅SiCl₃→C₆H₅SiH₃+(C₆H₅)H₂SiCl+(C₆H₅)HSiCl₂+6DIBACl

As illustrated in the reaction above, 3 mole of DIBAH is consumed to produce 1 mole of phenylsilane (C₆H₅SiH₃), 2 mole of DIBAH is consumed to produce 1 mole of phenylchlorosilane ((C₆H₅)H₂SiCl), and 1 mole of DIBAH is consumed to produce 1 mole of phenyldichlorosilane ((C₆H₅)HSiCl₂).

The hydrosilane compound, the reducing agent, and the solvent, if present, are fed into the microreactor via a positive displacement syringe pump at a flow rate of 24.3 mL Z min.

Table 1 below illustrates the results of Examples 1-11. In particular, Table 1 sets forth the molar ratio of the reducing agent to the halosilane compound, the selectivity of the phenylsilane (C₆H₅SiH₃), the selectivity of the phenylchlorosilane ((C₆H₅)H₂SiCl), the selectivity of the phenyldichlorosilane ((C₆H₅)HSiCl₂), and the conversion based on silicon, as described in greater detail below.

TABLE 1

| | | Molar Ratio of Reducing | C₆H₅SiH₃ | (C₆H₅)H₂SiCl | (C₆H₅)HSiCl₂ | Conversion |
|---|---|---|---|---|---|---|
| | Reducing | Agent:Halosilane | Selectivity | Selectivity | Selectivity | Based on Si |
| Example | Agent | Compound | Based on H (%) | Based on H (%) | Based on H (%) | (%) |
| Example 1 | 1 | 0.2 | 15.78 | 31.80 | 52.42 | 16.45 |
| Example 2 | 2 | 0.2 | 17.58 | 29.49 | 52.93 | 9.30 |
| Example 3 | 3 | 0.2 | 18.25 | 29.36 | 52.39 | 5.39 |
| Example 4 | 2 | 0.4 | 34.83 | 30.67 | 34.49 | 20.05 |
| Example 5 | 3 | 0.4 | 31.75 | 31.26 | 36.99 | 14.84 |
| Example 6 | 3 | 0.4 | 34.98 | 30.70 | 34.32 | 13.80 |
| Example 7 | 2 | 1.0 | 69.82 | 17.22 | 12.96 | 46.97 |
| Example 8 | 3 | 1.0 | 67.71 | 19.18 | 13.11 | 41.99 |
| Example 9 | 1 | 2.5 | 97.75 | 2.25 | 0.00 | 86.77 |
| Example 10 | 2 | 2.5 | 96.47 | 1.69 | 1.84 | 87.21 |
| Example 11 | 3 | 2.5 | 91.76 | 6.08 | 2.17 | 85.04 |

Reducing agent 1 comprises diisobutylaluminum hydride (DIBAH) in toluene in a concentration of 16 weight percent (1 M).

Reducing agent 2 comprises diisobutylaluminum hydride (DIBAH) in toluene in a concentration of 16 weight percent (1 M).

Reducing agent 3 comprises diisobutylaluminum hydride (DIBAH) in a concentration of 100 weight percent.

For calculating various selectivities and conversion, the following notations are utilized:

i=a final product formed from reducing the halosilane compound.

P₁=mole of phenylsilane (C₆H₅SiH₃) in the final product.

P₂=mole of phenylchlorosilane ((C₆H₅)H₂SiCl) in the final product.

P₃=mole of phenyldichlorosilane ((C₆H₅)HSiCl₂) in the final product.

P₄=mole of unreacted phenyltrichlorosilane (C₆H₅SiCl₃) in the final product.

x=mole of phenyltrichlorosilane (C₆H₅SiCl₃) in 100 grams of halosilane.

x−P₄=mole of phenyltrichlorosilane (C₆H₅SiCl₃) reacted per 100 grams of the final product.

Selectivity Based on Hydrogen (H):

Selectivity of the final product based on hydrogen is calculated as follows:

Selectivityᵢ=100*((mole of DIBAH converted to DIBACl)/(total mole of DIBAH reacted));

Selectivity(C₆H₅SiH₃)=100*((3*P₁)/(3*P₁+2*P₂+P₃));

Selectivity((C₆H₅)H₂SiCl)=100*((2*P₂) Z (3*P₁+2*P₂+P₃)); and

Selectivity((C₆H₅)HSiCl₂)=100*((P₃) Z (3*P₁+2*P₂+P₃)).

Conversion Based on Silicon (Si):

The amount of the halosilane compound, i.e., the phenyltrichlorosilane (C₆H₅SiCl₃), reacted during the step of reducing the halosilane compound is referred to as conversion and can be calculated as follows:

Conversion(C₆H₅SiCl₃)=100*((x−P₄) Z x)

As clearly illustrated in Table 1 above, the molar ratio of the reducing agent to the halosilane compound influences selectivity and conversion. For example, at lower molar ratios, such as 0.2, selectivity of the fully reduced species, i.e., C₆H₅SiH₃, ranged from 16.78 to 18.25. In contrast, at higher molar ratios, such as 2.5, selectivity of the fully reduced species, i.e., C₆H₅SiH₃, ranged from 91.76 to 97.75.

1. A method of producing a hydrosilane compound in a microreactor, said method comprising reducing a halosilane compound in the microreactor and in the presence of a reducing agent to produce the hydrosilane compound;
wherein the hydrosilane compound includes at least one more silicon-bonded hydrogen atom than the halosilane compound includes, if any, and wherein the halosilane compound includes at least one more silicon-bonded halogen atom than the hydrosilane compound includes, if any.

2. The method of claim 1 wherein the microreactor has a surface area to volume ratio of at least 1,500:1.

3. The method of claim 1 wherein the halosilane compound has the following general formula:
RₐH_{b}X_{4-a-b}Si,
wherein each R is independently selected from a substituted hydrocarbyl group, a unsubstituted hydrocarbyl group and an amino group, each X is independently a halogen atom, and a and b are each independently an integer from 0 to 3 with the proviso that a+b equals an integer from 0 to 3.

4. The method of claim 3 wherein the hydrosilane compound has the following general formula:
RₐH_{b+1}X_{4-a-b-1}Si.

5. The method of claim 3 wherein the hydrosilane compound has the following general formula:
RₐH_{b″}Si,
wherein b″ is an integer from 1 to 4, with the proviso that a+b″=4.

6. The method of claim 1 wherein the halosilane compound has the following general formula: 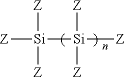
wherein each Z is independently selected from a substituted hydrocarbyl group, an unsubstituted hydrocarbyl group, an amino group, a hydrogen atom, and a halogen atom, with the proviso that at least one Z is a halogen atom, and n is an integer from 1 to 20.

7. The method of claim 6 wherein the hydrosilane compound has the following general formula: 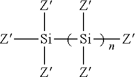
wherein each Z′ is independently selected from a substituted or unsubstituted hydrocarbyl group, an amino group, a hydrogen atom, and a halogen atom, with the proviso that at least one Z′ is a hydrogen atom, and n is an integer from 1 to 20 so long as the hydrosilane compound includes at least one more silicon-bonded hydrogen atom than the halosilane compound includes, if any.

8. The method of claim 1 wherein the step of reducing the halosilane compound comprises formally replacing at least one silicon-bonded halogen atom of the halosilane compound with at least one hydrogen atom to produce the hydrosilane compound.

9. The method of claim 1 wherein the step of reducing the halosilane compound comprises replacing every silicon-bonded halogen atom of the halosilane compound with a hydrogen atom to produce the hydrosilane compound.

10. The method of claim 1 wherein the reducing agent is selected from the group of diisobutylaluminum hydride (DIBAH), sodium dihydro-bis-(2-methoxyethoxy)aluminate (Vitride), aluminum hydride, lithium hydride, sodium hydride, sodium borohydride, lithium aluminum hydride, sodium aluminum hydride, lithium borohydride, magnesium hydride, calcium hydride, titanium hydride, zirconium hydride, and combinations thereof.

11. The method of claim 1 wherein the hydrosilane compound is a gas at ambient conditions.

12. The method of claim 1 wherein reducing the halosilane compound comprises reducing the halosilane compound in the microreactor and in the presence of the reducing agent and a carrier vehicle other than the hydrosilane compound, the halosilane compound, and the reducing agent to produce the hydrosilane compound.

13. The method of claim 12 wherein the carrier vehicle is a solvent selected from hydrocarbon solvents, ether solvents, and combinations thereof.

14. The method of claim 1 wherein the reducing agent and the halosilane compound are utilized in a molar ratio of from 0.01:1.0 to 5.0:1.0 to produce the hydrosilane compound.

15. A hydrosilane compound produced in accordance with the method of claim 1.

16. The method of claim 2 wherein the halosilane compound has the following general formula:
RₐH_{b}X_{4-a-b}Si,
wherein each R is independently selected from a substituted hydrocarbyl group, a unsubstituted hydrocarbyl group and an amino group, each X is independently a halogen atom, and a and b are each independently an integer from 0 to 3 with the proviso that a+b equals an integer from 0 to 3.

17. The method of claim 16 wherein the hydrosilane compound has the following general formula:
RₐH_{b″}Si,
wherein b″ is an integer from 1 to 4, with the proviso that a+b″=4.

18. The method of claim 17 wherein the reducing agent and the halosilane compound are utilized in a molar ratio of from 0.01:1.0 to 5.0:1.0 to produce the hydrosilane compound.
